(19) United States
(12) Patent Application Publication
(10) Pub. No.: US 2020/0082427 A1
(43) Pub. Date: Mar. 12, 2020

(54) Payment and Merchant Loyalty Based on Customer Identifiers

(71) Applicant: The Toronto-Dominion Bank, Toronto (CA)

(72) Inventors: Bryan Michael Gleeson, Bowmanville (CA); Jeffrey Aaron Ecker, North York (CA); Adam Douglas McPhee, Waterloo (CA); Matta Wakim, Petersburg (CA); Kyryll Odobetskiy, Waterloo (CA); John Jong-Suk Lee, Toronto (CA)

(73) Assignee: The Toronto-Dominion Bank, Toronto (CA)

(21) Appl. No.: 16/126,227

(22) Filed: Sep. 10, 2018

(51) Int. Cl. G06Q 30/02

(52) U.S. Cl. CPC G06Q 30/0226; G06Q 30/0215; G06Q 30/0238

(57) ABSTRACT

The present disclosure involves systems, software, and computer implemented methods for performing loyalty analyses and offers at point-of-sales (POSs). One example POS terminal includes a communications module, an interface, a display, and memory storing instructions and a plurality of preloaded bank identification numbers (BINs). The instructions instruct the terminal to receive credentials associated with a single instrument associated with a particular customer and used in a current data exchange. A BIN associated with the single instrument is identified and a determination is made as to whether it is included in the plurality of BINs. If included, an analysis is initiated comprising transmitting customer identification information and a set of current data exchange information to the institution associated with the particular BIN, the information used to identify an offer associated with the current data exchange. An offer is received from the institution, and can be presented to the display.

### TECHNICAL FIELD

The present disclosure relates to computer-implemented methods, software, and systems for performing loyalty analyses and offers at point-of-sales (POSs) without requiring users to provide additional loyalty credentials or using a merchant-specific card or input.

### BACKGROUND

Current loyalty programs at various merchants allow users to identify themselves via a personalized login, a scanned barcode or other unique identifiers provided in addition to payment credentials, or a merchant-linked card or associated account. For example, users or customers may apply for and be issued a card specific to a particular merchant. When that card or analogous payment instrument is used at the corresponding merchant, the card may be explicitly linked to the merchant and allow the merchant to link the purchase or transaction to a specific customer account linked to the merchant. Alternatively, an issued card may include two different customer identifiers, one for payment purposes and one for customer loyalty programs. To use the card, two swipes may be required, one to provide payment credentials and one to provide loyalty information, particularly for legacy point-of-sales (POSs). In other instances, POSs may be able to obtain both credentials in a single swipe by capturing and identifying the two different numbers that are tied to the card. However, in each solution, the card or payment instrument must be issued for and tied to a specific set of payment credentials in order to use associated loyalty programs.

### SUMMARY

The present disclosure involves systems, software, and computer implemented methods for performing loyalty analyses and offers at point-of-sales (POSs) without requiring users to provide additional loyalty credentials or using a merchant-specific card or input. A first example system comprises a POS terminal, wherein the POS terminal includes an interface, a communications module, a POS display, and at least one memory, and at least one hardware processor interoperably coupled with the at least one memory, the interface, the POS display, and the communications module. The at least one memory can store instructions and a plurality of preloaded bank identification numbers (BINs) received from one or more institutions, where each BIN is associated with a single, particular institution. The instructions can instruct the at least one hardware process to perform a series of operations.

In one implementation, the operations can include receiving, via the interface, credentials associated with a single instrument associated with a particular customer and used in a current data exchange. Based on the received credentials, a BIN associated with the single instrument is identified. A determination can be made as to whether the BIN associated with the instrument is included in the plurality of BINs. In response to determining that the BIN associated with the instrument is included in the plurality of BINs, an analysis can be initiated. In some instances, the analysis can include transmitting, via the communications module, customer identification information and a set of current data exchange information to the institution associated with the particular BIN, wherein the customer identification information and the set of current data exchange information is used by the institution to identify an offer associated with the current data exchange. An offer can then be received via the communications module from the institution associated with the current data exchange. The received offer can be presented to the POS display. In response to receiving input associated with acceptance of the offer, the current data exchange can be processed using the credentials.

Implementations can optionally include one or more of the following features.

In some instances, the interface comprises a payment interface, the one or more institutions comprise one or more financial institutions, the credentials comprise payment credentials, the data exchange comprises a transaction, the instrument comprises a payment instrument, the analysis comprises a loyalty analysis, and wherein the offer comprises a loyalty-related offer.

In those instances, in response to determining that the BIN associated with the payment instrument is not included in the plurality of BINs, the current transaction can be processed without initiating and performing the loyalty analysis.

In those instances, receiving the loyalty-related offer from the financial institution associated with the current transaction can include, at the financial institution, receiving, via a communications module at the financial institution, the customer identification information and the set of current transaction information. Based on the determined BIN, at least one loyalty-related offer from the financial institution associated with the current transaction can be determined. The at least one loyalty-related offer from the financial institution can be transmitted, via the communication module at the financial institution, to the POS terminal.

In an alternative of those instances, receiving the loyalty-related offer from the financial institution associated with the current transaction can include, at the financial institution, receiving, via a communications module at the financial institution, the customer identification information and the set of current transaction information. An account associated with the customer identification information can be identified. Historical transactional information associated with the identified account can be compared to at least one loyalty offer threshold associated with at least one loyalty offer. In response to identifying that the at least one loyalty offer threshold is met or exceeded based on the comparison, transmitting, via the communication module of the financial institution, the at least one loyalty-related offer associated with the current transaction from the financial institution to the POS terminal. In those instances, the at least one loyalty threshold can correspond to a number of prior transactions at the location of a merchant at which the POS is located. In other instances, the at least one loyalty threshold can correspond to a number of prior transactions associated with the merchant at which the POS is located.

In some of those instances, the payment instrument can comprise one of a credit card or a debit card.

In some of those instances, the customer identification information can comprise a personal account number (PAN), wherein the BIN comprises a defined portion of the PAN. In others of those instances, the customer identification information comprises a personal account number (PAN), and the BIN may not be included in the PAN.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for performing loyalty analyses and offers at point-of-sales (POSs).

FIG. 2 is an illustration of a data and control flow of example interactions performed by a system performing loyalty analyses and offers at point-of-sales (POSs).

FIG. 3 is a swimlane diagram of an example implementation for performing the loyalty analyses described herein.

FIG. 4 is a flow diagram for performing loyalty analyses and offers at point-of-sales (POSs) in one particular example implementation.

### DETAILED DESCRIPTION

The present disclosure describes various tools and techniques associated with performing loyalty analyses and generating offers for presentation at point-of-sales (POSs). In particular, the present solution is meant to allow users to provide payment credentials or information related to a data exchange associated with a transaction identifying the user. The terminal used to perform the transaction can receive data exchange credentials via any suitable manner, including through a payment interface (e.g., a card reader), a barcode or other encoding scanner, a wireless communications method or standard (e.g., Near-Field Communication, NFC) interface, or any other suitable component. Information related to a unique customer identifier can be obtained at the POS during the data exchange. At least a portion of the customer identifier can then be compared to one or more stored identifiers at the POS, including, but not limited to, a bank identification number (BIN), a personal account number (PAN), or other data exchange information. If the customer identifier matches the stored identifiers, the POS can initiate a loyalty analysis based on the correspondence in addition to performing the requested data exchange. To perform the loyalty analysis, the POS can provide information associated with the data exchange, along with the customer identifier information, to a financial server or other backend system at which a loyalty analysis can be performed. Because the loyalty determination is based on the customer identifier associated with the data exchange, and not specific loyalty information provided by the customer, the solution provides a card- and loyalty-agnostic solution that allows financial institutions and their related loyalty systems to perform a real-time loyalty analysis without requiring additional input or specific card or payment instruments on the part of the customer. In some instances, the stored identifiers may be specifically associated with or owned by the corresponding financial institutions, such that, in response to determining that the customer identifier corresponds to a financial institution-owned stored identifier, additional information about the transaction and the particular customer can be used to generate a tailored or loyalty program-specific offer for the user.

In one particular example, the financial institution may be a bank, and the POS may be managed by, provided by, or otherwise authorized by the bank. A set of BINs corresponding to the bank can be loaded on the POS, and can be used to perform an initial analysis of whether a set of payment credentials received at the POS are associated with the bank. If not, the transaction can be processed normally, and no further loyalty analysis may be performed. If, however, the credentials are associated with the bank, then information about the transaction and the user can be provided to the bank and its loyalty systems to identify potential loyalty offers. Those potential loyalty offers may be of any particular type, and may be generally available to bank customers or bank customers of particular types (e.g., not specific to the user, but offered generally for customers with a particular account type). In other instances, an analysis of the customer, their prior transactions, and one or more loyalty program criteria for a particular merchant can be identified and evaluated to determine whether any offers are available for the current transaction. The loyalty analysis can be performed by the bank, or may be performed in association with a third party loyalty system. The solution allows banks to use detailed customer information and history to determine whether a customer meets loyalty requirements associated with the current transaction (e.g., meets a threshold number of purchases at this merchant over a period of time, spending over time exceeds threshold, etc.). In some instances, the system can provide that information to the merchant and facilitate a relationship between the customer and the merchant to create a loyalty account and allow further loyalty interactions between the parties. In other instances, the solution can allow loyalty-based rewards to be earned without requiring customers to register with the merchant, where the transaction history of the user from the bank provides, at least in part, the determination of whether one or more loyalty offers are to be extended in the current transaction. Once a loyalty offer is identified, the bank can provide information back to the POS, where the POS can present the loyalty offer to the customer. If the customer chooses to use the loyalty offer and redeem the benefits, the selection can be recorded by the bank and registered in the loyalty systems.

One example transaction may be a customer using a Target 5% discount card, where the customer identifier is identified as within the BIN range associated with a particular financial institution and securely stored at the Target POS. After 5 uses of the card, the customer may qualify for an additional discount (e.g., 10%) and can apply it to the current transaction. The customer may use the existing discount card, but based on the additional customer history and the analysis performed, the additional loyalty offer can be identified and provided at the POS. Such a solution can allow the bank and merchant to provide insights to customer behavior, including identifying repeat visitors, identifying cards or payment accounts associated with a similar group (e.g., a particular BIN range that relates to a particular card type), or others. In some instances, the loyalty offer may include an additional upsell option based on the customer's prior and current transactions.

In some instances, the solution may include a determination that the customer is not already linked to the current merchant's loyalty program. While some loyalty offers may be available to customers of the bank, the current solution can evaluate a customer's transaction history to determine whether an offer to join the merchant's loyalty program should be provided and/or recommended. The POS, through the solution, can provide interactions for the customer to perform should the offer be provided. In those instances, once the customer is entered and associated with a new loyalty program, additional or alternative offers may be available. Further, the bank can connect or update the customer account with information identifying that user's relationship to the loyalty account. In future transactions, the bank may be able to use that loyalty account information in determining appropriate offers and analysis.

In general, however, the described solution is able to provide loyalty offers and benefits without the user necessarily being registered with a particular merchant loyalty program. In doing so, financial institution customers are identified based on their particular customer identifier, such as a portion or the whole of their card or payment number (e.g., their card's BIN). Once the determination is made at the POS, transaction information and the customer identifier are provided to the financial server, where a loyalty analysis is performed regardless of their current merchant loyalty membership. Using customer information, including the customer's transaction history, the loyalty determination is performed and an offer is presented at and via the POS. In some instances, BIN-specific loyalty offers can be made available to groups of customers with similar types of cards or accounts.

The illustrated examples of the present disclosure are meant to provide example implementations of the solution, and are not meant to be limiting.

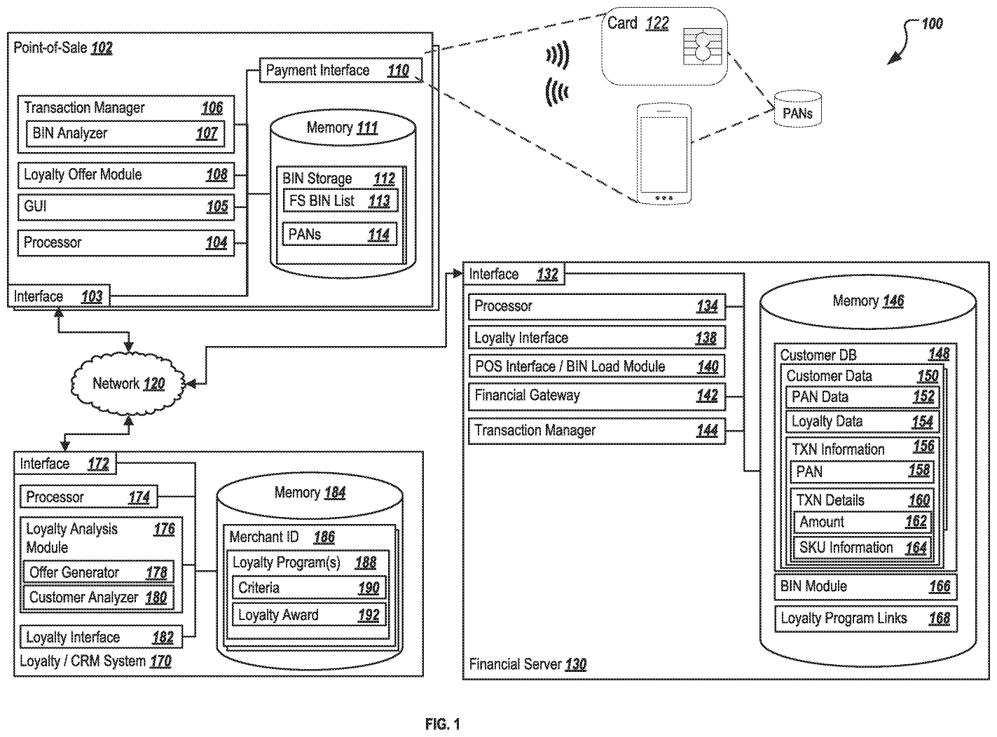

Turning to the illustrated example implementation, FIG. 1 is a block diagram illustrating an example system 100 for performing loyalty analyses and offers at point-of-sales (POSs). System 100 includes functionality and structure associated with receiving data exchange credential (e.g., payment card information) from a user via one or more POSs 102, where the POSs are associated with and/or managed by a financial institution related to at least one financial server 130. The POSs 102 can communicate via network 120 with the financial server(s) 130, which, in some implementations, may communicate with a loyalty or CRM system 170 (hereinafter, loyalty system 170). In some instances, the loyalty system 170 may be included within or a part of the financial server 130, while in others, may be separate from or apart from the financial server 130. As will be described, the POS 102 can securely store a set of account identifiers, such as BINs, associated with different payment instruments provided by or associated with the financial institution. The BINs can be loaded into the POSs' BIN storage 112 via any suitable mechanism. When a data exchange action, such as an attempted payment, is performed at the POS 102, a local analysis of the received payment instrument and the contents of the BIN storage 112 can be performed to determine whether the payment instrument is associated with or provided by the financial institution. If so, a loyalty-free loyalty analysis can be performed based on the current transaction and a set of customer information stored at a customer database 148 of the financial server 130, which can be used to identify whether or not loyalty offers are available for the current transaction. Those offers can then be presented via the POS 102, such as through graphical user interface (GUI) 105, and can be accepted and/or applied by the customer. If not, the transaction can be processed using standard processes without performing the further operations.

As illustrated, system 100 includes or is communicably coupled with one or more POSs 102, financial server 130, and the loyalty system 170, each connected via network 120. System 100 is a single example of a possible implementation, with alternatives, additions, and modifications possible for performing some or all of the described operations and functionality. Although other components are shown separately, in some implementations, functionality of two or more systems, servers, or illustrated components may be provided by a single system or server. In some implementations, the functionality of one illustrated system or server may be provided by multiple systems, servers, or computing devices, including those physically or logically local or remote to each other. For example, financial server 130 may actually be represented by multiple servers and other components in other instances. Further, as noted, the loyalty system 170 may be included with or a part of the financial server 130. Any combination or permutation of systems may perform the functionality described herein. In some instances, particular operations and functionality described herein may be executed at either the POS 102, the financial server 130, or the loyalty system 170, or at one or more other non-illustrated components, as well as at a combination thereof.

As used in the present disclosure, the term “computer” is intended to encompass any suitable processing device. For example, POS 102, the financial server 130, and the loyalty system 170 may be any computer or processing device (or combination of devices) such as, for example, a blade server, general-purpose personal computer (PC), Mac®, workstation, UNIX-based workstation, embedded system or any other suitable device. Moreover, although FIG. 1 illustrates particular components as a single element, those components may be implemented using a single system or more than those illustrated, as well as computers other than servers, including a server pool or variations that include distributed computing. In other words, the present disclosure contemplates computers other than general-purpose computers, as well as computers without conventional operating systems. POS 102 may be any system which can request data, execute an application (e.g., transaction manager 106), and/or interact with the financial server 130. In some instances, the POS 102 may be any other suitable device, including a mobile device, such as a smartphone, a tablet computing device, a smartwatch, a laptop/notebook computer, or a connected device, where those devices allow customers to provide payment credentials to the POS 102 and complete one or more data exchanges. Additionally, the POS 102 may be a desktop or workstation, server, or any other suitable device, as well as a device specifically designed to interact with financial server 130. Similarly, the financial server 130 may be a server, a set of servers, a cloud-based application or system, or any other suitable system providing functionality associated with processing requested data exchanges from the POS 102 and performing the operations described herein. In general, each illustrated component may be adapted to execute any suitable operating system, including Linux, UNIX, Windows, Mac OS®, Java™ Android™, Windows Phone OS, iOS™, a proprietary operating system and/or applications, among others.

Illustrated system 100 includes at least POS 102, and may include a plurality of POSs 102 in some instances. Each POS 102 may generally be any computing device operable to connect to or communicate within the system 100 via the network 120 using a wireline or wireless connection. In general, the POS 102 comprises an electronic computer device operable to receive, transmit, process, and store any appropriate data associated with the system 100 of FIG. 1. As illustrated, the POS 102 can include one or more applications, including a transaction manager 106 and a loyalty offer module 108, as illustrated in FIG. 1. In some instances, the loyalty offer module 108 may be part of the transaction manager 106. The transaction manager 106 may be any program or application used to manage data exchange transactions performed at the POS 102. In some instances, the transaction manager 106 may also be a part of a process associated with loading one or more customer identifiers associated with a particular financial institution into memory 111 of the POS 102. The customer identifiers may uniquely identify a particular customer (e.g., a personal account number (PAN), such as a full credit card number) or may identify an identifier or set of identifiers included in information received at the POS 102, and which relate to, are issued by, or correspond to the financial institution associated with the financial server 130. The POS 102 can securely store, in BIN storage 112, a list 113 of financial institution-associated BINs. Those BINs may identify all BINs issued by or associated with a particular financial institution, or may identify a subset of BINs issued by or associated with the financial institution. In some instances, only certain cards or payment types may be associated with the loyalty-free loyalty provided by the solution, with only some of the cards being associated with the stored BINs. In some instances, BINs and other identifiers associated with multiple different financial institutions may be separately stored in memory 111, such as where a third-party POS provider provides the POS 102. Depending on the particular BIN identified, the financial server 130 of the appropriate financial institution can be contacted using the described process.

In some instances, the BIN storage 112 may also include one or more PANs 114, where the PANs list specific account numbers associated with different customers. Alternatively, any other suitable identifier can be used instead of BINs or PANs, which specifically associates a received set of data exchange credentials with one or more financial institutions. For example, the data exchange credentials may be constructed in a certain order or format. Using information based on that format, one or more associated financial institutions may be identified. The format may be based on length of the data exchange credential, contents of the credential, or any other suitable information obtained from the data exchange. The analysis at the POS is what, if any, financial institutions registered with or linked to the POS 102 are associated with the received data exchange credentials or information.

Returning to the transaction manager 106, the transaction manager 106 can perform the standard operations associated with the POS 102. The transaction manager 106 may receive, from a payment interface 110, a set of information from one or more cards 122 and other payment instruments received at the POS 102. The transaction manager 106 can perform local processing associated with the data exchange, and can transmit, via interface 103, information associated with the data exchange to the financial gateway 142 of the financial server. The transaction manager 106 can include a BIN analyzer 107 for performing the comparison of the received data exchange credentials with the information stored in the BIN storage 112. As described, the comparison is used to determine whether a particular financial institution is associated with the data exchange credentials received for the attempted data exchange, and if so, the transaction manager 106 can communicate additional transaction information and customer identifying information to the financial server 130.

The POS 102 can also include a loyalty offer module 108, which can communicate with the loyalty system 170, either directly or via the financial server 130, and can be used to present any identified loyalty offers to the customer via GUI 105 for display and acceptance. In some instances, the loyalty offer module 108 may be included in or a part of the transaction manager 106. In some instances, the loyalty offer module 108 may perform some or all of the functionality of the loyalty system 170 locally at the POS 102. In some instances, the loyalty offer module 108 may store information associated with a subset of possible loyalty offers for a merchant, and can perform a local analysis based on information obtained from the financial server 130 about the customer and in light of the current transaction.

Payment interface 110 may be any suitable interface used to receive and/or input data exchange credentials from one or more users or customers. As illustrated, the payment interface 110 may read or receive information from one or more credit or debit cards 122, mobile devices (e.g., mobile phones with a mobile wallet), and/or other components. The information may be received via a card swipe, an NFC interaction (e.g., using a smart card or a mobile device), or any other suitable interaction. In some instances, the POS 102 may be associated with a cloud- or internet-based payment input, allowing inputs to be received via suitable Internet-connected web pages and/or apps which can provide information to the POS 102. Using information obtained from the interaction, the payment interface 110 can provide the information to the transaction manager 106, which can use the BIN analyzer 107 to perform the financial institution analysis. The transaction manager 106 can provide the payment instrument information to the financial gateway 142 of the financial server 130. In some instances, the transaction manager 106 may identify the particular matching BIN or identifier found to match the data exchange credentials in any communications to the financial gateway 142.

The POS 102 may include any suitable input components used to receive information and interact with customers. For example, a keypad, touchscreen, camera, microphone, or other input components may be included in the POS 102. Additionally, one or more output components used to convey information associated with the POS 102 and its applications, including any loyalty offers, can be included with the POS. Example output components may include, but are not limited to, a display, one or more speakers, or any other suitable output components. The display may be GUI 105, and can present digital data and visual information, while other output components can provide auditory or tactile feedback. GUI 105 can interface with at least a portion of the environment 100 for any suitable purpose, including generating a visual representation of any screens or displays associated with the POS 102 and its transaction manager 106 and/or the loyalty offer module 108, including presentation of a pop-up or push notification or preview, presenting the UI associated with the loyalty offer module 108 or the transaction manager 106, or any other suitable presentation of information. GUI 105 may also be used to view and interact with various Web pages, applications, and Web services located local or external to the POS 102, such as those related to or associated with either the merchant or the financial institution. Generally, the GUI 105 provides the user with an efficient and user-friendly presentation of data provided by or communicated within the system. The GUI 105 may comprise a plurality of customizable frames or views having interactive fields, pull-down lists, and buttons operated by the user. For example, the GUI 105 may provide interactive elements that allow a user to view or interact with information related to the operations of processes associated with the financial server 130 and/or the loyalty system 170 and any associated systems, among others. In general, the GUI 105 is often configurable, supports a combination of tables and graphs (bar, line, pie, status dials, etc.), and is able to build real-time portals, application windows, and presentations. Therefore, the GUI 105 contemplates any suitable graphical user interface, such as a combination of a generic web browser, a web-enabled application, intelligent engine, and command line interface (CLI) that processes information in the platform and efficiently presents the results to the user visually.

As illustrated, the POS 102 includes an interface 103. Interface 103 is used by the POS 102 for communicating with other systems in a distributed environment—including within the environment 100—connected to the POS 102 and/or network 120, e.g., financial server 130 and/or loyalty system 170, as well as other systems or components communicably coupled to the network 120. Generally, the interface 103 comprises logic encoded in software and/or hardware in a suitable combination and operable to communicate with the network 120 and other communicably coupled components. More specifically, the interface 103 may comprise software supporting one or more communication protocols associated with communications such that the transaction manager 106, loyalty offer module 108, the network 120, and/or the interface's hardware is operable to communicate physical signals within and outside of the illustrated environment 100.

Network 120 facilitates wireless or wireline communications between the components of the environment 100 (e.g., between combinations of the POS 102, financial server 130, loyalty system 170, and/or the other components, among others) as well as with any other local or remote computer, such as additional mobile devices, clients, servers, remotely executed or located portions of a particular component, or other devices communicably coupled to network 120, including those not illustrated in FIG. 1. In the illustrated environment, the network 120 is depicted as a single network, but may be comprised of more than one network without departing from the scope of this disclosure, so long as at least a portion of the network 120 may facilitate communications between senders and recipients. In some instances, one or more of the illustrated components (e.g., the financial server 130 or loyalty system 170) or portions thereof may be included within network 120 as one or more cloud-based services or operations. The network 120 may be all or a portion of an enterprise or secured network, while in another instance, at least a portion of the network 120 may represent a connection to the Internet. In some instances, a portion of the network 120 may be a virtual private network (VPN) or an Intranet. Further, all or a portion of the network 120 can comprise either a wireline or wireless link. Example wireless links may include 802.11a/b/g/n/ac, 802.20, WiMax, LTE, and/or any other appropriate wireless link. In other words, the network 120 encompasses any internal or external network, networks, sub-network, or combination thereof operable to facilitate communications between various computing components inside and outside the illustrated environment 100. The network 120 may communicate, for example, Internet Protocol (IP) packets, Frame Relay frames, Asynchronous Transfer Mode (ATM) cells, voice, video, data, and other suitable information between network addresses. The network 120 may also include one or more local area networks (LANs), radio access networks (RANs), metropolitan area networks (MANs), wide area networks (WANs), all or a portion of the Internet, and/or any other communication system or systems at one or more locations.

The POS 102 also includes one or more processors 104. Although illustrated as a single processor 104 in FIG. 1, multiple processors may be used according to particular needs, desires, or particular implementations of the environment 100. Each processor 104 may be a central processing unit (CPU), an application specific integrated circuit (ASIC), a field-programmable gate array (FPGA), or another suitable component. Generally, the processor 104 executes instructions and manipulates data to perform the operations of the POS 102, in particular those related to executing the various modules illustrated therein and their related functionality. Specifically, the processor 104 executes the algorithms and operations described in the illustrated figures, as well as the various software modules and functionalities, including the functionality for sending communications to and receiving transmissions from various components in the illustrated system 100, as well as to process transactions via the transaction manager 106 and receive information via the payment interface 110, among others. Each processor 104 may have a single core or multiple cores, with each core available to host and execute an individual processing thread.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, Objective-C, JavaScript, Java™, Visual Basic, assembler, Perl®, Swift, HTML5, any suitable version of 4GL, as well as others.

As illustrated, the POS 102 includes memory 111. In some implementations, the POS 102 includes a single memory or multiple memories. The memory 111 may include any type of memory or database module and may take the form of volatile and/or non-volatile memory including, without limitation, magnetic media, optical media, random access memory (RAM), read-only memory (ROM), removable media, or any other suitable local or remote memory component. The memory 111 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the POS 102. Additionally, the memory 111 may store any other appropriate data, such as VPN applications, firmware logs and policies, firewall policies, a security or access log, print or other reporting files, as well as others. As illustrated, memory 111 includes, for example, the BIN storage 112 described above. Memory 111 may store any other suitable contents, including instructions associated with the BIN analyzer 107, or other suitable data and information. In some instances, some or all of the data included in memory 111 in FIG. 1 may be located outside of the POS 102, including within network 120 as cloud-based storage and data, or remote at the financial server 130, where appropriate.

The financial server 130 of FIG. 1 represents one or more servers, systems, or other components that perform operations associated with a financial institution to assist in processing one or more data exchanges, particularly those associated with POS 102. In some instances, the POS 102 may be a remote component of the financial server 130, performing POS functionality at a remote location, such as a merchant or for one or more entities. The POS 102 can provide transaction-related information to the financial server 130 via the POS interface 140, where the transactions can be processed using the financial gateway 142. Additionally, when the data exchange credentials used for a data exchange are associated with the financial institution of the financial server 130, the transaction manager 144 can be used to further process a loyalty-related analysis. The transaction manager 144 can obtain the information from the POS interface 140, identify relevant customer information based on the transaction and credentials, and provide any suitable information to the loyalty system 170 via the loyalty interface 138. The loyalty system 170 can perform a loyalty analysis based on the received information to determine if one or more offer criteria are met, and, if so, return one or more offers to the POS 102 (in some instances, via the financial server 130). In response to customer interactions at the POS 102, including acceptance or declining of any provided offers, the POS 102 can provide the selected transaction information and process the transaction via the financial gateway 142.

As illustrated, financial server 130 includes an interface 132 (similar or different to interface 103), at least one processor 134 (similar or different to processor 104), the loyalty interface 138 for interacting with the loyalty system 170, a POS interface 140 for interacting with the POS 102, the financial gateway 142, the transaction manager 144, and memory 146 (similar to or different to memory 111). Different implementations may include additional or alternative components, with FIG. 1 meant to be an example illustration of one possible implementation. While illustrated separate from one another, at least some of these described elements may be combined within a single component or system, or may be implemented separate from one another, including at different systems, computers, and/or at remote components.

Memory 146 may include, store, or reference a customer database 148, a BIN module 166, and one or more loyalty program links 168, among other information or data. The customer database 148 may store information identifying particular customers or customer accounts (generally, customer data 150), including one or more PANs 152 associated with payment instruments issued to a particular customer, loyalty data 154 identifying one or more loyalty programs with which the customer is associated or registered, and sets of different historical transactional information 156 associated with prior usages of particular cards and payment instruments of the user. The PAN data 152 may include information identifying particular accounts and cards associated with the user and issued from the financial institution. In some instances, different accounts for a user can be combined or associated so that transactions of the customer using different accounts can be linked and evaluated together. In other instances, PAN-specific information may be used without cross-reference or connection to other accounts. The loyalty data 154 may be used to link a customer and/or a particular PAN 152 to a particular loyalty account or set of information. In some instances, the loyalty data 154 may be used to identify one or more loyalty programs to which the customer is linked or registered, with the loyalty program links 168 storing information on the particular connections or loyalty systems 170 to which those accounts or registrations relate.

The information included in the customer data 150 may include any suitable information used to assist in a determination of whether a particular customer is eligible for particular offers associated with the loyalty system 170. In the illustrated example, a set of transaction-specific information 156 can include a series of historical transactions. In instances where different cards or payment instruments are grouped for a customer, the transaction information 156 may identify a particular PAN 158 used for a transaction, as well as a set of transaction details 160. The details 160 may include any particular information, including merchant information (e.g., Target), merchant location information (e.g., Target in Toronto, Ontario on 1^{st} Street), an amount of the transaction 162, information on particular articles or purchases in a transaction, such as SKU information 164, as well as other information not shown. Additional information may include a date and time of the transaction, links to one or more related transactions, and additional or alternative information. The customer data 150 can link, reference, or include any set of data relevant to a customer and the loyalty analysis.

As illustrated, memory 146 also includes a BIN module 166, which stores information on one or more BINs associated with the financial institution. The POS interface 140 can include or incorporate a BIN load module that is used to load particular POSs 102 with a particular set of BINs. There may be multiple BIN modules 166 used for different types of POSs 102, or for different merchants or operators of the particular POSs 102. The POS interface 140 can connect to the POS 102 via a secure connection (e.g., using encoded and/or encrypted communications, a VPN connection, etc.) and upload a set of BINs from the BIN module 166 to the appropriate POS 102. In other instances, secure drives may be used to manually upload BINs onto the POS 102 in person, or the POSs 102 may be loaded prior to delivery and/or shipment to the corresponding merchant. Once loaded, as described, the transaction manager 106 of the POS 102 can determine, using the BIN analyzer 107, whether the BINs associated with a current data exchange match or correspond to one of the loaded BINs in the BIN storage 112 received from and associated with the financial institution.

In response to a match being identified, and an indication of the same being received from the POS 102 (e.g., via the POS interface 140), the transaction manager 144 may operate to obtain the relevant information from the customer database 148 and provide any such information to the loyalty system 170 (e.g., via loyalty interface 138). The loyalty interface 138 may be used for communication with the loyalty server 170, including through a secure connection. The transaction manager 144 can provide data or metadata associated with the current transaction, historical transactions of the customer, or other suitable information so that the loyalty system 170 can perform a loyalty analysis.

As illustrated, the loyalty system 170 describes or represents a system, server, or combination of computers that can perform functionality associated with analyzing a current and/or historical transactions of a customer to determine whether one or more loyalty offers can be provided or generated for a user. The loyalty system 170, while illustrated as separate from the financial server 130, may be included in or a part of the financial server 130 or a larger financial system in different implementations. In general, the loyalty system 170 can determine whether an offer is available for the current customer based on the current transaction, historical transactions, or both, and can relay the offer to the POS 102 via one or more channels (e.g., directly or via the financial server 130).

As illustrated, the loyalty system 170 includes an interface 172 (which may be similar to or different from interfaces 103 and/or 132), a processor 174 (which may be similar to or different from processors 104 and 134), a loyalty analysis module 176, a loyalty interface 182, and memory 184 (which may be similar to or different from memories 111 and 146). The loyalty analysis module 176, via the loyalty interface 182 to the POS 102 and financial server 130, can receive transactional information related to the current transaction from the POS 102 and/or the financial server 130, and can obtain historical transactional information from the financial server 130. Based on that information, the loyalty analysis module 176 can analyze the current customer (e.g., using a customer analyzer 180) and generate any suitable loyalty offers (e.g., via the offer generator 178). The particular loyalty programs 188 can be associated with one or more merchants or merchant IDs 186. Each loyalty program 188 may be associated with one or more loyalty awards 192 and corresponding criteria required for a customer to be eligible for a particular award. In some instances, the criteria 190 may be associated with a number of prior visits or transactions. In other instances, the criteria 190 may be based on an amount being spent in the current transaction. In other instances, a combination of historical and current transactional information may be required in order for the criteria 190 to be met. In some instances, the loyalty system 170 may track prior loyalty awards for the customer, while in others, such historical loyalty activity may be stored in the customer data 150.

Based on the loyalty analysis and the customer analyzer 180, the offer generator 178 can generate one or more loyalty offers for which the customer qualifies. The offers can be transmitted, either directly or via the financial server 130, to the loyalty offer module 108 of the POS 102, and subsequently presented to the customer prior to completing the transaction. If the customer accepts, the POS 102 can apply the offer, as appropriate, and can perform the transaction via the financial gateway 142.

The present solution described throughout this present disclosure and in FIG. 1 may be associated with an opt-out mechanism, allowing customers to specifically elect not to receive loyalty offers at POSs 102 of their associated financial institution. In other instances, the solution may be associated with an opt-in process prior to generating loyalty offers. All data may be stored in an encrypted format at the POS 102, with various security precautions taken to protect the data and secure information.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

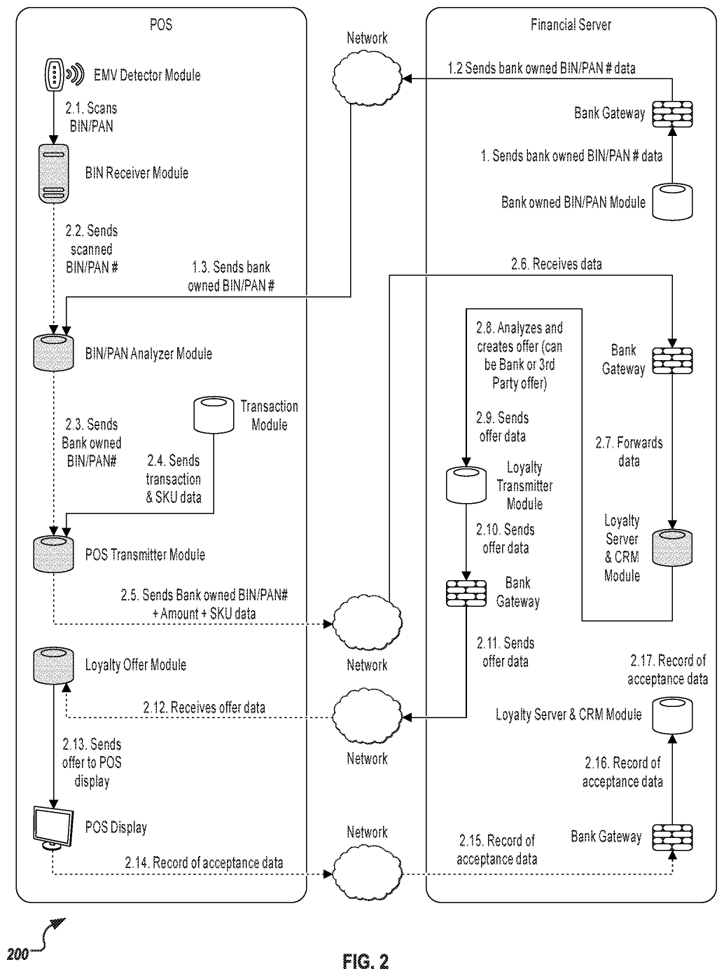

FIG. 2 is an illustration of a data and control flow 200 of example interactions performed by a system performing loyalty analyses and offers at point-of-sales (POSs). Portions of the description relate to the illustration of FIG. 1, although alternative implementations may be used to perform the actions illustrated in FIG. 2.

Initially, a bank-owned BIN and/or PAN module can send (at 1) a set of bank-owned BIN and/or PAN data, via a secure bank gateway (at 1.2), to a BIN module (e.g., the BIN/PAN analyzer module of the POS via a secure network connection at 1.3). Those BINs/PANs can be stored and used to evaluate future transactions for potential loyalty determinations.

At 2.1, an EMV detector module (or any suitable payment interface such as payment interface 110) can scan or detect payment credentials received from a payment instrument, credit/debit card, or mobile device. The scanned credentials can be provided to a BIN receiver module, which can send scanned BINs and/or PANs to the BIN/PAN analyzer module for evaluation at 2.2.

When the BIN/PAN analyzer module identifies a bank-owned BIN or PAN from the transaction, the loyalty without a loyalty card analysis can be performed. First, the BIN/PAN analyzer module sends, at 2.3, the bank-owned BIN or PAN to a POS transmitter module used to interact with the financial server of the bank. Additionally, at 2.4, a transaction module of the POS can provide, to the POS transmitter module, transaction data of the current transaction, including in some instances, SKU-level data as captured at the POS.

At 2.5, the POS transmitter module can send, via the network, bank-owned BIN/PAN numbers associated with the transaction to the financial server, along with any suitable transaction data, including an amount and SKU-level data, in some instances. Through the network, the bank gateway can receive the sent data (at 2.6), and can forward the data to a loyalty system (at 2.7). The loyalty system may be a part of the financial server, a CRM system associated with the financial institution, and/or a standalone system.

As described in FIG. 1, at 2.8, the loyalty system, based on the transaction information of the current transaction and/or historical information associated with the customer, may analyze and create an offer based on the available information. In some instances, the offer may be customer-agnostic, and can instead be offered to any customer associated with a particular BIN or a particular type of card. In other instances, the offer may be specific to the customer based on their current transaction and/or historical transactions. The particular offer generated may be generated or provided by the financial institution or bank itself, or may be provided and/or made available by a 3^{rd} party, including the merchant associated with the transaction. At 2.9, the offer data can be provided to a loyalty transmitter module, which can prepare, formalize, and/or standardize the offer as needed, and can transmit the offer data to the bank gateway (at 2.10), which can relay the offer through the network (2.11) to the loyalty offer module of the POS, which receives the offer data at 2.12.

The loyalty offer module can further modify or prepare the offer for presentation, and can send the offer to a POS display or screen at 2.13. The customer can accept the offer via the POS display, such as through a touchpad or other input keys. Once accepted, the POS can send a record of acceptance to the loyalty server via the network (2.14), which can forward the acceptance to the bank gateway (at 2.15), which can forward the record of acceptance data to the loyalty server. The loyalty server can then save the record of acceptance data (at 2.17), and, in some instances, update customer data indicating that the loyalty offer was used. The use of the loyalty offer can be used in future loyalty analyses to determine whether additional offers should be made.

Various uses of the loyalty offers can be provided in different solutions. In one solution, a customer may have previously transacted with a merchant multiple times. Based on the prior interactions, a loyalty offer may be available, either from the bank or from the merchant. If the prior interactions and the current interaction are such that a loyalty threshold is met, then a loyalty offer can be generated. In some instances, in response to a new transaction at a particular merchant, the customer may be automatically signed up for a loyalty program with the merchant based on their current interaction. In such instances, the customer's information may be provided through the POS or alternatively, based on customer information from the financial server. In addition, or as an incentive to accept the offer to join the merchant loyalty program, an additional offer, such as a discount to the current transaction, may be offered.

In general, the loyalty offer may be any offer related to a loyalty program, and may not necessarily include an offer for a discount on a current transaction. The offer may include an offer to join a merchant loyalty program, an offer to join a bank-managed loyalty program, a discount or purchasing promotion, an offer for a deal or discount on a future transaction, an offer for points or other suitable rewards program, or any other suitable offer.

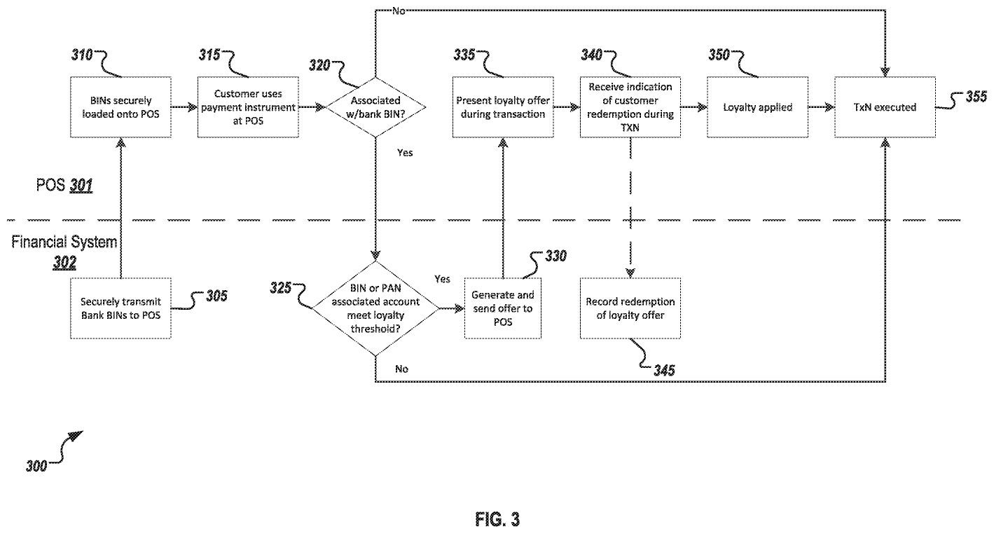

FIG. 3 is a swimlane diagram 300 of a first example implementation for performing the loyalty analyses described herein. The illustration is meant to be one example of the current solution, and is not meant to be limiting.

At 305, financial system 302 can securely transmit a set of bank BINs to POS 301. The set of bank BINs may include a subset of all BINs issued by the financial institution. In some cases, that set of bank BINs may be based on the particular merchant to be operating the POS 301. In other instances, a full set of BINs associated with payment instruments issued by the financial institution associated with the financial system 302 can be transmitted to the POS 301.

At 310, the BINs are securely loaded onto the POS 301, such as in a secure memory or storage location. At 315, a customer can interact with the POS 301 and provide a payment instrument to perform a data exchange and/or financial transaction. At 320, a determination is made by the POS 301 to determine whether the payment instrument received at 315 is associated with one of the bank BINs stored at the POS 301. The analysis can identify a portion or all of an identifier associated with the payment instrument and compare it to the stored BINs. If a match or association is identified, operations can continue at 325 and a loyalty offer analysis can be performed by the financial system 302. If, however, the current customer is not associated with the financial institution and its BINs, operations can continue at 355, where the data exchange or financial transaction is performed without the loyalty analysis.

At 325, a determination is made as to whether the bank BIN or a PAN associated with the account meet a loyalty threshold associated with the loyalty system. The loyalty threshold can be based on any number of factors, and may include a BIN-based analysis or a customer-based analysis, among others. In a BIN-based analysis, the fact that a payment instrument includes a particular BIN may be determinative of whether a loyalty offer is available. For example, certain types of cards (e.g., a TD Rewards card) may be eligible for a loyalty offer at a particular merchant based on the use of the card alone, regardless of the particular customer using the card. In those instances, the threshold is met for a particular loyalty offer based solely on the BIN or bank identifier. In other instances, a deeper customer-specific analysis is performed by the financial system and the loyalty system—which are combined here for simplicity of explanation.

In a customer-based analysis, information associated with the current transaction, as well as historical transactions associated with the customer, can be considered by the financial system 302 in determining whether a particular loyalty threshold is met at 325. In some instances, the loyalty threshold may be related to a number of transactions performed at a current location of the POS, a number of transactions performed with a merchant associated with the POS, a number of transactions performed at a competitor of the merchant associated with the POS or in a related category or industry (e.g., groceries, movie tickets, etc.), whether certain goods or services are included in the current transaction, whether the customer is already linked to an existing loyalty program for the merchant associated with the POS, or any other number of considerations. The determination may identify the PAN associated with the payment instrument, and use the PAN to identify the customer and the related transactions and accounts to evaluate.

If, at 325, a determination is made that the BIN or PAN or related account associated with the transaction meets the loyalty threshold, the method 300 continues at 330, where the financial system 302 can generate a suitable offer and transmit that offer back to the POS 301. If, however, no loyalty thresholds are met, method 300 can continue at 355, where the transaction is executed without a loyalty offer. In some instances, a notification can be sent to the POS 301 indicating that no loyalty offers are available.

At 330, the appropriate offer or offers associated with the met or exceeded loyalty thresholds can be generated and transmitted to the POS 301. Generating the offers can include generating instructions associated with the available offer or offers, including, in some instances, instructions for the POS 301 on how to present the information, as well as how to adjust the current transaction should one or more of the offers be redeemed at the POS 301. In some instances, the offers may be ranked, and only a subset may be transmitted back to the POS 301 (e.g., a top 3 of 6 possible and ranked offers).

At 335, the POS 301 can receive the loyalty offers and present the offers at an associated display, where the customer can accept or decline the offers. In some instances, the POS 301 or the financial system 302 may communicate the offers directly to a device associated with the customer, such as a mobile device associated with a customer account, or a mobile device used at the POS 301 to pay. In those instances, the customer may be able to accept or decline such offers from the device, which can communicate the response to the POS 301, either directly through a local connection (e.g., NFC) or through an Internet-based connection. If no offer is accepted, method 300 can continue at 355. If, however, at least one of the offers are accepted or an indication of redemption is received at 340, the POS 301 can apply the loyalty offer at 350 to the current transaction, if applicable. Additionally, a record of redemption of the loyalty offer can be transmitted to the financial system 302 and recorded at 345.

Applying the loyalty offer can adjust the current transaction in various ways, or may not cause any changes to the current transaction, but to a future transaction or loyalty status. Potential loyalty offers may include providing a discount on one or more items in the current transaction or to the total amount of the transaction. In other instances, one or more items, goods, or services may be offered in addition to the current set of items included in the transaction, such as further goods or services at a discount. One example may include a gas station transaction where the loyalty offer identifies a certain amount of gas being purchased, and offers a drink or food item at a discount based on the loyalty analysis. In other instances, the loyalty offer may be to join a loyalty program associated with the current merchant or offered by the financial institution of the financial server 302. In those instances, benefits of the loyalty program may not be immediately realized, but can allow the customer to accrue points, rewards, or other credit for the current transaction. In other instances, discounts or offers for a next transaction may be offered, either for the current merchant associated with the POS 301 or another merchant, including a competitor of the current merchant, or a related merchant to the current transaction.

At 350, the redeemed loyalty offer is applied. The loyalty offer, as noted, may adjust the current transaction or may affect an account associated with the customer. Once applied, the current transaction can be executed at 355 based on any applied loyalty offers.

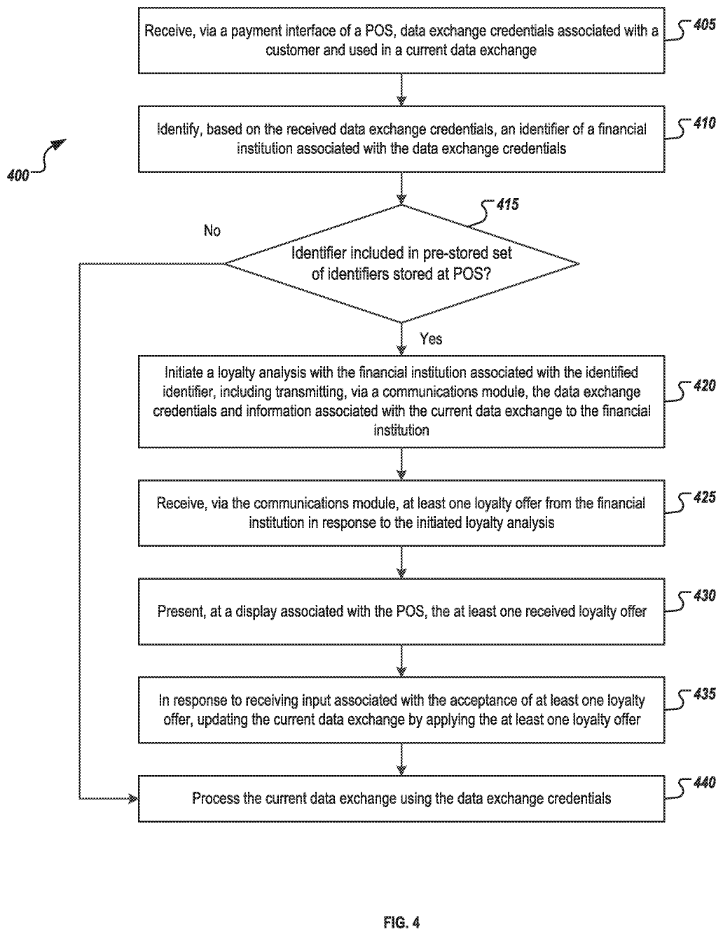

FIG. 4 is a flow diagram of an example method 400 for performing loyalty analyses and offers at point-of-sales (POSs) in one particular example implementation. It will be understood that method 400 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute method 400. In some implementations, the method 400 and related methods are executed by one or more components of the system 100 described above with respect to FIG. 1, or the components described in FIG. 2, among others.

At 405, a set of data exchange credentials associated with a customer and used in a current data exchange are received via a payment interface of a POS. The data exchange credentials may be associated with a payment instrument, such as an existing credit or debit card. In some instances, the data exchange credentials may be a PAN associated with the payment instrument, where the PAN uniquely identifies a particular account and associated customer or user.

At 410, an identifier of a financial institution associated with the data exchange credentials is identified. The identifier may be a portion of the data exchange credentials, or it may be determinable from a format or context of the data exchange credentials. Where the data exchange credentials are a PAN, a portion of the PAN may be a BIN (bank identification number) which can be used to identify the financial institution that issued the payment instrument of the data exchange.

As described herein, POSs can pre-store a set of BINs (and/or PANs) associated with a particular financial institution. By doing so, a determination can be made at a financial institution-related POS as to whether a current data exchange is being performed with a customer of the financial institution, thereby allowing further analysis of one or more loyalty offers without requiring the customer to provide additional loyalty identification or use a second card or payment instrument. At 415, a determination is made as to whether the identified identifier of the financial institution corresponds to or otherwise matches one of the pre-stored set of identifiers stored at the POS. Where the stored identifiers are PANs, a comparison of whether a known PAN is pre-stored in the POS can be determined. In some instances, full PANs may be used for the comparison where a financial institution is smaller, or a particular set of accounts are to be associated with a transaction and corresponding loyalty offer analysis.

If the identifier is not included in the pre-stored set of identifiers, then method 400 continues at 440, where the current data exchange is processed using the data exchange credentials. This operation can occur where the data exchange credentials are not associated with a financial institution managing or associated with the POS, and can simply allow the data exchange to occur without the value-added operations of the loyalty analysis.

If, however, the identifier is included in the pre-stored set of identifiers, then method 400 continues at 420, as the determination is made that the data exchange credentials are associated with the financial institution associated with or providing the POS. Once the determination is made, the POS can initiate a loyalty analysis with the financial institution. To initiate that operation, the POS can transmit, via a communications module of the POS, the set of data exchange credentials received at 405 and information associated with the current data exchange to the financial institution (e.g., its financial server).

While not illustrated in FIG. 4, the financial institution can perform the loyalty analysis in its own systems or may forward a set of relevant information to a loyalty system separate from its systems. The loyalty analysis may be based on any number of loyalty criteria used to determine whether the current data exchange and/or the history of data exchanges associated with the current customer are associated with or qualify for one or more loyalty offers. The prior descriptions describe example threshold values associated with various loyalty offers, where those thresholds can be set by merchants associated with the loyalty analysis, the financial institution itself, or one or more third parties. The loyalty system can determine one or more loyalty offers to be provided, and can transmit back a set of offer information. In some instances, the loyalty offers may be customer-specific (e.g., based on the customer's historical transactions in light of the current transaction), while in others, such offers may be related to the financial institution or a class of payment instruments used to conduct the data exchange by the customer (e.g., because the customer used a particular rewards card, the offer is provided to the customer), among others.

At 425, the POS can receive, via the communications module, at least one loyalty offer from the financial institution in response to the initiated loyalty analysis. The at least one loyalty offer may include details of how a current data exchange should be modified if the offer is accepted, as well as how the offer should be presented.

At 430, the POS can present, at a display associated with the POS and/or the customer, the at least one received loyalty offer. The display may be integral to the POS, or the display may be provided at the customer's mobile device in some instances. In some example implementations, presentation of the offers may be sent directly to the mobile device by the financial institution and/or the loyalty system, where the customer can accept the offer via the mobile device. Such acceptance can be relayed back to the POS directly or via the Internet.

At 435, in response to receiving input associated with the acceptance of at least one loyalty offer, the current data exchange can be updated by applying the at least one loyalty offer at the POS. In some instances, the loyalty offer may not affect or change the current data exchange, but can be related to a loyalty account and/or the earning of points or rewards related to a loyalty account. Where all offers are declined, 435 can be skipped.

At 440, the current data exchange can be processed using the data exchange credentials received at 405. If a loyalty offer is accepted and affects the data exchange, then the current data exchange comprises a modified data exchange from that provided in 405.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system comprising a point-of-sale (POS) terminal, the POS terminal comprising:
an interface;
a communications module;
a POS display;
at least one memory storing instructions and a plurality of preloaded bank identification numbers (BINs) received from one or more institutions, where each BIN is associated with a single, particular institution; and
at least one hardware processor interoperably coupled with the at least one memory, the interface, the POS display, and the communications module, wherein the instructions instruct the at least one hardware processor to:
receive, via the interface, credentials associated with a single instrument associated with a particular customer and used in a current data exchange;
identify, based on the received credentials, a BIN associated with the single instrument;
determine whether the BIN associated with the instrument is included in the plurality of BINs; and
in response to determining that the BIN associated with the instrument is included in the plurality of BINs, initiate an analysis, the analysis comprising:
transmitting, via the communications module, customer identification information and a set of current data exchange information to the institution associated with the particular BIN, wherein the customer identification information and the set of current data exchange information is used by the institution to identify an offer associated with the current data exchange;
receiving, via the communications module, an offer from the institution associated with the current data exchange; and
presenting, via the POS display, the received offer; and
in response to input associated with acceptance of the offer, processing the current data exchange using the credentials.

2. The system of claim 1, wherein the interface comprises a payment interface, the one or more institutions comprise one or more financial institutions, the credentials comprise payment credentials, the data exchange comprises a transaction, the instrument comprises a payment instrument, the analysis comprises a loyalty analysis, and wherein the offer comprises a loyalty-related offer.

3. The system of claim 2, wherein the instructions further instruct the at least one hardware processor to:
in response to determining that the BIN associated with the payment instrument is not included in the plurality of BINs, process the current transaction without initiating the loyalty analysis.

4. The system of claim 2, wherein receiving the loyalty-related offer from the financial institution associated with the current transaction comprises, at the financial institution:
receiving, via a communications module at the financial institution, the customer identification information and the set of current transaction information;
determining, based on the determined BIN, at least one loyalty-related offer from the financial institution associated with the current transaction; and
transmitting, via the communication module at the financial institution, the at least one loyalty-related offer from the financial institution to the POS terminal.

5. The system of claim 2, wherein receiving the loyalty-related offer from the financial institution associated with the current transaction comprises, at the financial institution:
receiving, via a communications module at the financial institution, the customer identification information and the set of current transaction information;
identifying an account associated with the customer identification information;
comparing historical transactional information associated with the identified account to at least one loyalty offer threshold associated with at least one loyalty offer; and
in response to identifying that the at least one loyalty offer threshold is met or exceeded based on the comparison, transmitting, via the communication module of the financial institution, the at least one loyalty-related offer associated with the current transaction from the financial institution to the POS terminal.

6. The system of claim 5, wherein the at least one loyalty threshold corresponds to a number of prior transactions at the location of a merchant at which the POS is located.

7. The system of claim 5, wherein the at least one loyalty threshold corresponds to a number of prior transactions associated with the merchant at which the POS is located.

8. The system of claim 2, wherein the payment instrument comprises one of a credit card or a debit card.

9. The system of claim 2, wherein the customer identification information comprises a personal account number (PAN), and wherein the BIN comprises a defined portion of the PAN.

10. The system of claim 2, wherein the customer identification information comprises a personal account number (PAN), and wherein the BIN is not included in the PAN.

11. A non-transitory, computer-readable medium storing computer-readable instructions, the instructions, when executed by one or more computers, cause the one or more computers to:
receive, via an interface associated with a point-of-sale (POS) terminal, credentials associated with a single instrument associated with a particular customer and used in a current data exchange;
identify, based on the received credentials, a bank identification number (BIN) associated with the single instrument;
determine whether the BIN associated with the instrument is included in a plurality of BINs stored in at least one memory associated with the POS terminal, wherein each BIN associated with a single, particular institution; and
in response to determining that the BIN associated with the instrument is included in the plurality of BINs, initiate an analysis, the analysis comprising:
transmitting customer identification information and a set of current data exchange information to the institution associated with the particular BIN, wherein the customer identification information and the set of current data exchange information is used by the institution to identify an offer associated with the current data exchange;
receiving, via a communications module of the POS terminal, an offer from the institution associated with the current data exchange; and
presenting, via a display of the POS terminal, the received offer; and
in response to input associated with acceptance of the offer, processing the current data exchange using the credentials.

12. The non-transitory, computer-readable medium of claim 11, wherein the interface comprises a payment interface, the institutions comprise financial institutions, the credentials comprise payment credentials, the data exchange comprises a transaction, the instrument comprises a payment instrument, the analysis comprises a loyalty analysis, and wherein the offer comprises a loyalty-related offer.

13. The non-transitory, computer-readable medium of claim 12, wherein the instructions cause the one or more computers to, in response to determining that the BIN associated with the payment instrument is not included in the plurality of BINs, processing the current transaction without initiating the loyalty analysis.

14. The non-transitory, computer-readable medium of claim 12, wherein receiving the loyalty-related offer from the financial institution associated with the current transaction comprises, at the financial institution:
receiving, via a communications module at the financial institution, the customer identification information and the set of current transaction information;
determining, based on the determined BIN, at least one loyalty-related offer from the financial institution associated with the current transaction; and
transmitting, via the communication module at the financial institution, the at least one loyalty-related offer from the financial institution to the POS terminal.

15. The non-transitory, computer-readable medium of claim 12, wherein receiving the loyalty-related offer from the financial institution associated with the current transaction comprises, at the financial institution:
receiving, via a communications module at the financial institution, the customer identification information and the set of current transaction information;
identifying an account associated with the customer identification information;
comparing historical transactional information associated with the identified account to at least one loyalty offer threshold associated with at least one loyalty offer; and
in response to identifying the at least one loyalty offer threshold met or exceeded based on the comparison, transmitting, via the communication module of the financial institution, the at least one loyalty-related offer associated with the current transaction from the financial institution to the POS terminal.

16. The non-transitory, computer-readable medium of claim 15, wherein the at least one loyalty threshold corresponds to a number of prior transactions at the location of a merchant at which the POS is located.

17. The non-transitory, computer-readable medium of claim 15, wherein the at least one loyalty threshold corresponds to a number of prior transactions associated with the merchant at which the POS is located.

18. The non-transitory, computer-readable medium of claim 12, wherein the payment instrument comprises one of a credit card or a debit card.

19. The non-transitory, computer-readable medium of claim 12, wherein the customer identification information comprises a personal account number (PAN), and wherein the BIN comprises a defined portion of the PAN.

20. A computerized method performed by one or more processors, the method comprising:
receiving, via an interface associated with a point-of-sale (POS) terminal, credentials associated with a single instrument associated with a particular customer and used in a current data exchange;
identifying, based on the received credentials, a bank identification number (BIN) associated with the single instrument;
determining whether the BIN associated with the instrument is included in a plurality of BINs stored in at least one memory associated with the POS terminal, wherein each BIN associated with a single, particular institution; and
in response to determining that the BIN associated with the instrument is included in the plurality of BINs, initiating an analysis, the analysis comprising:
transmitting customer identification information and a set of current data exchange information to the institution associated with the particular BIN, wherein the customer identification information and the set of current data exchange information is used by the institution to identify an offer associated with the current data exchange;
receiving, via a communications module of the POS terminal, an offer from the institution associated with the current data exchange; and
presenting, via a display of the POS terminal, the received offer; and
in response to input associated with acceptance of the offer, processing the current data exchange using the credentials.
